(19) United States
(12) Patent Application Publication
(10) Pub. No.: US 2018/0232775 A1
(43) Pub. Date: Aug. 16, 2018

(54) SYSTEM AND A METHOD FOR SELECTING TARGET CANDIDATES TO PROVIDE A CONTENT

(71) Applicant: NHN PAYCO CORPORATION, Seongnam-si (KR)

(72) Inventors: Yu Won KIM, Seongnam-si (KR); Jin Kyo CHUNG, Seongnam-si (KR); Seung Meen HA, Seongnam-si (KR); Yeun Ha PARK, Seongnam-si (KR)

(21) Appl. No.: 15/892,871

(22) Filed: Feb. 9, 2018

(30) Foreign Application Priority Data
Feb. 10, 2017 (KR) 10-2017-0018918
Feb. 10, 2017 (KR) 10-2017-0018928

(51) Int. Cl. G06Q 30/02; G06F 17/30

(52) U.S. Cl. CPC G06Q 30/0269; G06Q 30/0273; G06F 17/30867

(57) ABSTRACT

A method of selecting a target candidate among user devices to which an advertisement content is provided including: receiving, by a data receiving unit of a first server from each user device, a unique data including device identification information and application information of each application installed in the user device; confirming, by the first server for each user device, the application installed in the user device from the unique data; applying, by the first server for each user device, an application weight to each application installed in the user device, the application weight being different for each application; summing, by the first server for each user device, the application weights applied to each installed application, and calculating a score of the user device based on the sum of the application weights; and selecting at least one of the user devices as the target candidate based on the score.

### CROSS REFERENCE TO RELATED APPLICATIONS

This application claims priority from and the benefits of Korean Patent Application No. 10-2017-0018918, filed on Feb. 10, 2017, and Korean Patent Application No. 10-2017-0018928, filed on Feb. 10, 2017, which are hereby incorporated by reference for all purposes as if fully set forth herein.

### BACKGROUND

### Field

Exemplary embodiments of the invention relate generally to a method and system for selecting a target candidate using information of applications installed in a device, and a method and system for providing a content to a selected target candidate, and, more specifically, to a method and system for predicting the probability that a device would perform a predetermined action.

### Discussion of Background

With the advancement of information technology (IT), the development direction of the IT industry has gradually shifted from a hardware emphasis to a software emphasis. Therefore, in the software industry, contents production has gained much attention, such as user created contents (UCC), where various people directly produce contents.

In particular, when a content developer develops a core source, the core source may be processed into a variety of content types by a one-source multi-use (OSMU) method, and these various contents may be provided to consumers.

For example, when a book is published, the source of the book may be converted into a drama, a movie, or a musical form, and various emoticons and character goods can be marketed from the characters of the book.

However, as the amount of contents increases exponentially over time, excessive contents may be provided to consumers, which makes it difficult for consumers to quickly search for the desired content from the excessive contents, thereby exposing the consumers to what is known as information pollution.

Meanwhile, in order to promote the sale of goods and services, or to improve social image of a corporation or a group, contents including such information may be provided to the consumers through various media. More particularly, unlike other industrial fields, the field of advertisement is generally very sensitive to changes in the surrounding environment, and thus, may require a process that can quickly, actively, and sensitively respond to changes in the surrounding environment.

However, conventional advertisement contents have been transmitted to the consumers by using only a limited number of types of media, such as TVs, newspapers, and radios, despite the unique characteristics of an advertisement field, which makes it difficult to reflect the quick, active, and sensitive nature of advertisement field into advertisement contents, and provide the contents to the public. In other words, while the needs of the consumers are changing very rapidly and variously, the medium of delivering the advertisement contents is limited, and thus, it may be difficult to provide advertisement contents that meet the consumer's needs in terms of diversity, promptness, and accuracy to the public.

The above information disclosed in this Background section is only for enhancement of understanding of the background of the inventive concepts, and, therefore, it may contain information that does not form the prior art that is already known in this country to a person of ordinary skill in the art.

### SUMMARY

Exemplary embodiments of the invention are directed to solving the problems discussed above. More particularly, exemplary embodiments relate generally to a method and system for selecting a target candidate by calculating the probability of a user device performing a predetermined action based on applications installed each user device, and to a method and system for providing a content to the selected target candidate.

Additional features of the inventive concepts will be set forth in the description which follows, and in part will be apparent from the description, or may be learned by practice of the inventive concepts.

According to an exemplary embodiment, a method of selecting a candidate among a plurality of user devices to which an advertisement content is provided includes: receiving, by a data receiving unit of a first server from each user device, a unique data including device identification information of the user device and application information of each application installed in the user device; confirming, by the first server for each user device, the application installed in the user device from the unique data; applying, by the first server for each user device, an application weight to each application installed in the user device, the application weight being different for each application; summing, by the first server for each user device, the application weights applied to each installed application, and calculating a score of the user device based on the sum of the application weights; and selecting at least one of the user devices as the target based on the score.

The unique data may further include user-specific information including at least one of gender, age, marital status, location, and income group of each user using the user device, and each of the gender, age, marital status, location, and income group of the user-specific information may be assigned with a user-specific information weight different from one another.

Each of the application weight and user-specific information weight may be calculated by using a logistic regression method, and the score of each user device may be calculated by adding the application weights and the user-specific information weights of the corresponding user device.

The application weight for each application may be predetermined.

The score may represent a probability of whether the user device performs at least one of predetermined actions including playing the content, installing and operating an application, making a purchase payment, subscribing to a service, using a coupon, and responding to a survey.

According to an exemplary embodiment, a method of selecting a target candidate among a plurality of user devices to which an advertisement content is provided, includes: receiving, by a first server from each user device, unique data including user device identification information of the user device and application information of each application installed in the user device; checking, by the first server for each user device, whether the application in the unique data is installed in the user device; applying, by the first server for each user device, an application weight to each application installed in the user device, each application weight having different values from one another; summing, by the first server for each user device, the application weights applied to the installed applications, and calculating a score of the user device based on the sum of the application weights; selecting, by the first server, at least one user device as the target based on the score; transmitting, by the first server, at least one unique data of the user device selected as the target to a second server through a network; and identifying, by the second server, the target candidate from the at least one unique data, and providing the advertisement content to the target candidate.

The method may further include paying, by the second server, the advertisement fee to the first server.

The step of paying the advertisement fee may include receiving, by the second server from the target, action data indicating whether the target candidate has performed at least one of accessing the advertisement, installing and operating an application, making a purchase payment, subscribing to a service, using a coupon, and responding to a survey, and analyzing, by the second server, the action data received from the target candidate and paying the advertisement fee to the first server upon determining that the target candidate has performed the at least one of accessing the advertisement, installing an operating an application, making a purchase payment, subscribing to a service, using a coupon, and responding to a survey.

The advertisement fee may be paid to the first server if the number of times the advertisement has been provided to the target candidate exceeds a predetermined reference number.

The unique data may further include user-specific information including at least one of gender, age, marital status, location, and income group for each user using the user device, and each of the gender, age, marital status, location, and income group of the user-specific information may be assigned with a user-specific information weight different from one another.

Each of the application weight and user-specific information weight may be calculated by using a logistic regression method, and the score of each user device may be calculated by adding the application weights and the user-specific information weights of the corresponding user device.

The content of the advertisement may vary depending on the gender, age, marital status, location, and income group of the user of the user device selected as the target candidate.

According to an exemplary embodiment, a server for selecting a target candidate includes a data receiving unit configured to receive unique data from each user device, the unique data including user device identification information of the user device and application information of an application installed in the user device, an operating unit configured to identify applications installed in the user device from the unique data received, apply application weights to applications installed in the user device, respectively, and to calculate a score of each user device based on the sum of the application weights, and a candidate selection unit configured to select at least one user device as the target candidate based on the score of the corresponding user device.

The unique data may further include user-specific information including at least one of gender, age, marital status, location, and income group for each user using the user device, and each of the gender, age, marital status, location, and income group of the user-specific information may be assigned with a user-specific information weight different from one another.

The operation unit may be further configured to calculate the application weights and the user-specific information weights in a logistic regression method, and calculate a probability by summing the applications weights and user-specific information weights of the corresponding user device as a score.

The operating unit may be further configured to retrieve the stored application weights for each of the applications, and apply the application weights to the installed applications in the user device, respectively.

A system for providing an advertisement may include the server described above, the server configured to transmit the unique data of a user device selected as the target candidate, and a second server configured to receive the unique data, identify the target candidate from the unique data, and provide an advertisement to the target candidate.

The second server may be further configured to pay an advertisement fee to the server for the advertisement provided to the target candidate.

The second server may be further configured to receive action data from the user device indicating whether the user device selected as the target candidate has performed at least one of accessing to the provided advertisement, installing and operating an application, making a purchase payment, subscribing to a service, using a coupon, and responding to a survey, and analyze the received action data and paying the advertisement fee upon determining that the user device selected as the target candidate performed at least one of accessing to the provided advertisement, installing and operating an application, making a purchase payment, subscribing to a service, using a coupon, and responding to a survey.

The second server may be configured to pay the advertisement fee when the number of times the advertisement is provided to the user device selected as the target candidate exceeds a preset reference number.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram of a target candidate selection system according to an exemplary embodiment.

FIG. 2 is a flowchart illustrating a method of selecting a target candidate according to an exemplary embodiment.

FIG. 3 is a schematic diagram of an advertisement providing system for a target candidate according to an exemplary embodiment.

FIG. 4 is a flowchart of a content providing method for a target candidate according to an exemplary embodiment.

FIG. 5 is a flowchart illustrating a process of providing a content to a user device selected as a target candidate by a second server according to an exemplary embodiment.

FIG. 6 is a flowchart of an advertisement providing method for a target candidate according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

In exemplary embodiments, one or more components thereof may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to one or more exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, one or more components thereof may include or otherwise be associated with one or more memories (not shown) including code (e.g., instructions) configured to cause one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CD-RW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

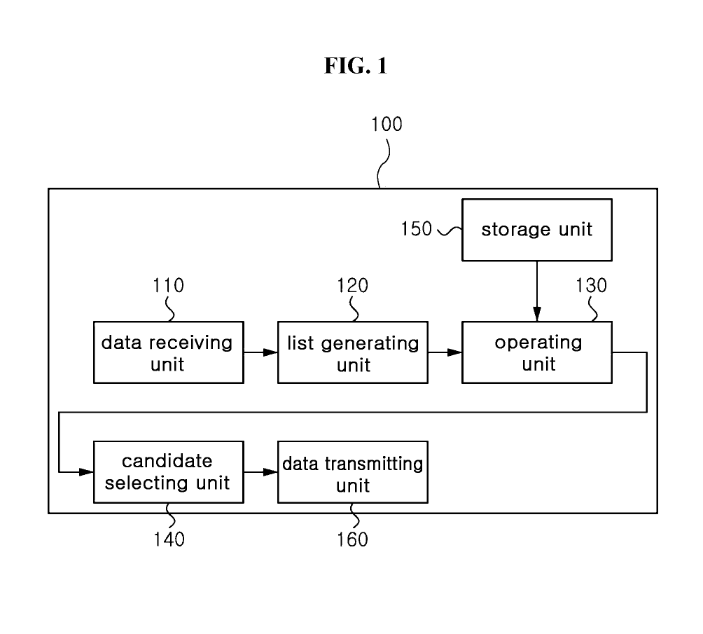

FIG. 1. is a block diagram of a target candidate selection system according to an exemplary embodiment.

The target candidate selection system 100 according to an exemplary embodiment of the invention includes a data receiving unit 110, a list generating unit 120, an operating unit 130, a candidate selecting unit 140, and a storage unit 150.

The data receiving unit 110 may receive unique data including identification information of a user device and application information of an application installed in the user device from at least one user device connected through a wire/wireless network. The unique data may further include user-specific information, such as at least one of gender, age, marital status, location, and income group for each user using the user device. Each element of the user-specific information may be given different weights for each entry of the user-specific information, which will be described in more detail below.

The operating unit 130 may identify an application installed in the user device from the unique data received. The operating unit 130 may then retrieve application weights pre-assigned to each application installed in the user device, which are set to be different from each other. The operating unit 130 may apply the pre-assigned application weight to each application installed in the user device, and may calculate a sum of the application weights in the user device, so as to calculate the probability the user device performing a predetermined action. More particularly, the operating unit 130 may calculate the application weights and the user-specific information weights by a logistic regression method, in order to calculate the probability indicative of whether the user device would perform a predetermined action, by adding the application weights and the user-specific information weights of the user device. The probability of each user device may be calculated as a score. According to an exemplary embodiment, the application weights and the user-specific information weights may be calculated differently depending on the types of marketing activities or types of servers performing the marketing activities.

The predetermined actions to be performed by the user device may include, for example, accessing an advertisement, installing and operating an application, making a purchase payment for goods or services, subscribing to a service, using a coupon, and responding to a survey. The logistic regression method may refer to a probability model that predicts the likelihood of an occurrence of an event, which is a dependent variable, using a linear combination of independent variables. More particularly, the logistic regression method is an analysis method used in a future prediction model by using the relationship between the dependent variable and the independent variable. The dependent variable may be based on categorical data, and when the input data is given, the outcome of the input data may be provided in specific categories.

In particular, when the operating unit 130 identifies an application installed in the user device from unique data received from at least one user device, the list generating unit 120 generates an application installation list for each user devices. The application installation list may include the names of all the applications installed in the user device that has transmitted the unique data to the data receiving unit 110.

The candidate selecting unit 140 selects a target candidate to which a marketing activity will be provided, so as to induce the target candidate to perform a predetermined action, based on the score calculated by the operating unit 130. In this case, the candidate selecting unit 140 may sort the scores in descending order, and select a user device as a target candidate based on a pre-set criteria, such as when the user device is within a preset rank, or when a user device exceeds a predetermined reference score.

The storage unit 150 stores application weights that are pre-assigned to each application, which have been previously collected through the payment agency platform. The storage unit 150 may also store a pre-set user-specific information weight for each entry of the user-specific information, which may include at least one of gender, age group, marital status, location, and an income group of a user, which may have different values from each other. In addition, the storage unit 150 stores an application installation list generated by the list generating unit 120 for each user device.

The target candidate selection system 100 according to the present exemplary embodiment may include the data receiving unit 110, the list generating unit 120, the operating unit 130, the candidate selecting unit 140, and the storage unit 150. The target candidate selection system 100 may further include a data transmitting unit 160.

The data transmitting unit 160 may transmit at least one unique data of the user device selected as the target candidate to an external server through a wired/wireless network. Accordingly, the external server may identify the user device selected as the target candidate from the unique data.

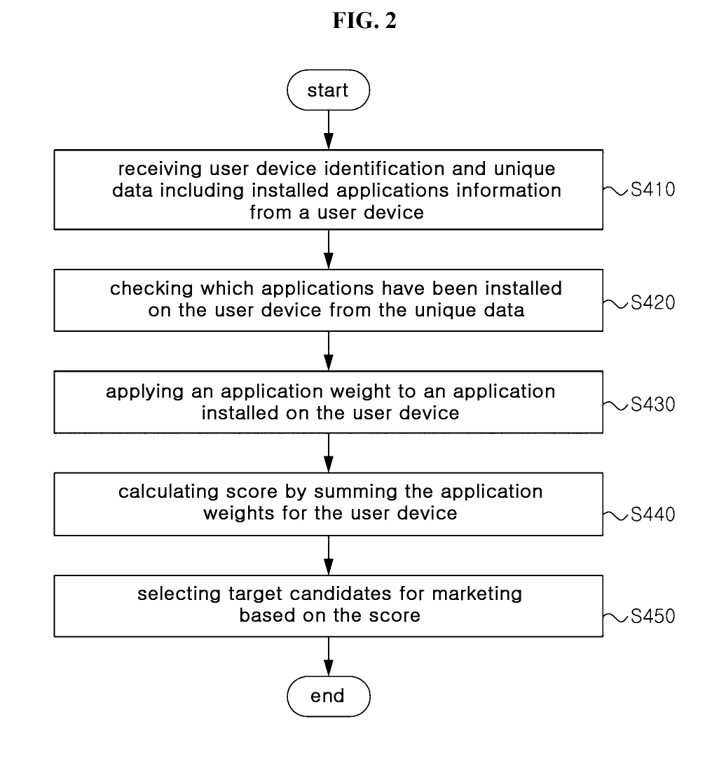

Hereinafter, a target candidate selection method according to an exemplary embodiment will be described in more detail with reference to FIG. 2.

FIG. 2 is a flowchart illustrating a method of selecting a target candidate according to an exemplary embodiment.

Referring to FIG. 2, in the target candidate selection method according to an exemplary embodiment, it is assumed that an application weight is stored in the storage unit 150. As described above, the application weight may be different for each application, and application information may be collected through the payment agency platform, such as PAYCO. In addition, it is also assumed that a user-specific information weight is stored in the storage unit 150. As described above, user-specific information may include at least one entries of gender, age, marital status, location, and income group of a user of a user device, and user-specific information for each user using the user device may be collected through the payment agency platform.

In step S410, the data receiving unit 110 receives unique data including identification information of the user device and application information of an application installed in the user device from at least one user device connected through a wired/wireless network. At this time, the unique data includes user-specific information including at least one entries of gender, age, marital status, location, and income group for each user who has an access to the user device, and each entry of the user-specific information may be individually assigned with user-specific information weight having different values from each other.

In step S420, the operating unit 130 identifies an application installed in the user device from the unique data received by the data receiving unit 110. At this time, when the operating unit 130 identifies the application is installed in the user device, the list generating unit 120 generates an application installation list for each application installed in the user device, which may be stored in the storage unit 150.

Table 1 below is an exemplary unique data received from the user devices 1 to N+M.

TABLE 1

| | Y | | | | | | | | |
|---|---|---|---|---|---|---|---|---|---|
| user | past | x | | | | | | | |
| device | performance | sex | age | com.starbuks.co | com.faceshop. | com.twitter | com.cjoclock | . . . | com.poom.main |
| user 1 | 1 | M | 35-39 | 1 | 0 | 0 | 0 | | 0 |
| user 2 | 0 | M | 40-44 | 0 | 0 | 0 | 0 | | 0 |
| user 3 | 1 | F | 40-44 | 0 | 0 | 0 | 0 | | 0 |
| . . . | | . . . | | | | | | | . . . |
| user N | 1 | M | 25-29 | 1 | 1 | 0 | 0 | | 1 |
| user | 0 | F | 40-44 | 0 | 1 | 0 | 0 | | 1 |
| (N + 1) | | | | | | | | | |
| user | 0 | F | 45-49 | 0 | 0 | 1 | 0 | | 0 |
| (N + 2) | | | | | | | | | |
| . . . | | . . . | | | | | | | . . . |
| user | 0 | F | 30-34 | 0 | 1 | 0 | 0 | | 0 |
| (N + M) | | | | | | | | | |

Through the items shown in Table 1, the operating unit 130 may determine that the data receiving unit 110 has received unique data including gender, age range, and installed application information from the user devices. For example, a user of the user device 1 is a male having an age between 35 and 39, and only the ‘Starbucks’ application corresponding to a food and beverage application is installed in the user device 1.

Further, it can be seen that the user of the user device N is a male having an age between 25 and 29, and the ‘Starbucks’ application, ‘The Face Shop’ application corresponding to a cosmetics application, and ‘POOM’ application corresponding to a shopping application are installed in the user device N.

Table 2 below shows an exemplary application installation list. The application installation list may include further information as needed, or the items shown in the application installation list may be changed according to the application information included in the unique data received by the data receiving unit 110.

TABLE 2

| | | | | | user |
|---|---|---|---|---|---|
| | | user | user | | device |
| variable | weight | device 1 | device 2 | . . . | N + 1 |
| default | −5.597007 | | | | |
| gender_M | 0.2931738 | M | M | | F |
| age_13-18 | −0.001719 | 35-39 | 40-44 | | 40-44 |
| age_19-24 | 0.0011754 | | | | |
| age_25-29 | 0.0588753 | | | | |
| age_30-34 | 0.849651 | | | | |
| age_35-39 | 0.1179367 | | | | |
| age_40-44 | 0.1247751 | | | | |
| age_45-49 | 0.0308248 | | | | |
| age_50-59 | 0.0011754 | | | | |
| age_60 | 0.000313 | | | | |
| com.starbucks.co | 0.5856063 | 1 | 0 | | 0 |
| com.shillaipark.kr | 0.5361948 | 0 | 0 | | 0 |
| com.nytimes.android | 0.2000939 | 0 | 0 | | 0 |
| com.cloudmosa.puffin | 0.1527142 | 1 | 0 | | 1 |
| com.hancom.interfree | 0.1309291 | 0 | 0 | | 1 |
| com.skp.seio | 0.0698032 | 1 | 0 | | 1 |
| kr/co.shiftworks.web | 0.0623287 | 0 | 0 | | 0 |
| com.nhn.android | 0.0338772 | 1 | 0 | | 1 |
| kr.cp.s,artskinlovej | 0.0317579 | 0 | 0 | | 1 |
| kr.co.aladin.third.shop | 0.0308248 | 0 | 0 | | 0 |
| com.sirma.mobile | 0.0245007 | 0 | 0 | | 0 |
| com.makeshop. | 0.0085378 | 1 | 1 | | 0 |
| flipboard.boxer.app | 0 | 1 | 1 | | 0 |
| com.mobeam.barcode | 0 | 1 | 0 | | 0 |
| com.skt.smartbill | 0 | 0 | 1 | | 1 |
| com.skmc.okcashback | 0 | 0 | 0 | | 0 |
| com.estosftalyac | 0 | 0 | 0 | | 0 |
| net.daum.android | −0.002855 | 0 | 0 | | 0 |
| com.judesk.android | −0.003892 | 1 | 1 | | 0 |
| com.nikosoftwares | −0.005154 | 1 | 0 | | 1 |
| com.somclouds.somt | −0.0057 | 0 | 1 | | 0 |
| com.skcomms.android | −0.010856 | 0 | 1 | | 0 |
| kr.co.easyinternet | −0.015545 | 0 | 0 | | 1 |
| com.tuck.hellomarket | −0.020794 | 0 | 0 | | 1 |
| com.buzzpia.aqua | −0.022467 | 0 | 0 | | 1 |
| com.kia.kr | −0.025168 | 0 | 0 | | 0 |
| kr.backpacidus | −0.027365 | 0 | 1 | | 0 |
| com.innoace.android | −0.030069 | 1 | 0 | | 0 |
| com.maeshop.maltail | −0.032566 | 0 | 1 | | 0 |
| com.imbc,mini | −0.033418 | 1 | 0 | | 1 |
| com.korail | −0.034081 | 0 | 0 | | 1 |
| ibk.android.ibkmv | −0.034262 | 0 | 1 | | 0 |
| com.ringdroid | −0.043811 | 1 | 0 | | 1 |
| com.digitalchemy | −0.053973 | 1 | 0 | | 1 |
| kr.co.nanumlotto | −0.059322 | 0 | 0 | | 0 |
| com.sampleapp | −0.068295 | 0 | 0 | | 1 |
| kr.co.nowcom | −0.072051 | 0 | 0 | | 1 |
| kr.go.cdc.nkp.android | −0.084044 | 0 | 1 | | 0 |
| com.qihoo.security | −0.087351 | 0 | 1 | | 0 |
| com.wiiricard.smart | −0.09715 | 0 | 0 | | 1 |
| com.teamviewer | −0.127911 | 0 | 0 | | 0 |
| com.ibk.bizacard | −0.41716 | 1 | 1 | | 0 |
| com.escapistagmames | −0.544767 | 0 | 0 | | 0 |
| com.theskinfood | −0.722614 | 0 | 1 | | 0 |

In step S430, an application weight to an application installed on the user device may be applied. More particularly, the operating unit 130 may retrieve the application weight stored in the storage unit 150, which have was previously assigned to each of the applications installed in the user device to have different values from each other, based on the unique data received by the operating unit 130. At this time, the operating unit 130 may also retrieve the user-specific information weight from the storage unit 150, which was previously assigned and includes at least one entries of gender, age, marital status, location, and income group for each user of the user device.

As shown in the following Table 3, the operating unit 130 may retrieve the application weights and the user-unique information weights from the storage unit 150. As described above, the applications weights are previously assigned for each application in the application installation list, and the user-unique information weights are received from the user devices. The application weights and user-unique information weights stored in the storage unit 150 may be calculated differently depending on the type of marketing activity or the type of server performing marketing activities, such as a merchant server.

TABLE 3

| | | | | | user |
|---|---|---|---|---|---|
| | | user | user | | device |
| variable | weight | device 1 | device 2 | . . . | N + 1 |
| default | −5.597007 | | | | |
| gender_M | 0.2931738 | M | M | | F |
| age_13-18 | −0.001719 | 35-39 | 40-44 | | 40-44 |
| age_19-24 | 0.0011754 | | | | |
| age_25-29 | 0.0588753 | | | | |
| age_30-34 | 0.849651 | | | | |
| age_35-39 | 0.1179367 | | | | |
| age_40-44 | 0.1247751 | | | | |
| age_45-49 | 0.0308248 | | | | |
| age_50-59 | 0.0011754 | | | | |
| age_60 | 0.000313 | | | | |
| com.starbucks.co | 0.5856063 | 1 | 0 | | 0 |
| com.shillaipark.kr | 0.5361948 | 0 | 0 | | 0 |
| com.nytimes.android | 0.2000939 | 0 | 0 | | 0 |
| com.cloudmosa.puffin | 0.1527142 | 1 | 0 | | 1 |
| com.hancom.interfree | 0.1309291 | 0 | 0 | | 1 |
| com.skp.seio | 0.0698032 | 1 | 0 | | 1 |
| kr/co.shiftworks.web | 0.0623287 | 0 | 0 | | 0 |
| com.nhn.android | 0.0338772 | 1 | 0 | | 1 |
| kr.cp.s,artskinlovej | 0.0317579 | 0 | 0 | | 1 |
| kr.co.aladin.third.shop | 0.0308248 | 0 | 0 | | 0 |
| com.sirma.mobile | 0.0245007 | 0 | 0 | | 0 |
| com.makeshop. | 0.0085378 | 1 | 1 | | 0 |
| flipboard.boxer.app | 0 | 1 | 1 | | 0 |

In step S440, the operating unit 130 adds up the application weights assigned to the applications installed in the respective user devices, and calculates the probability of each user device performing predetermined actions. As used herein, performing a predetermined action may include, for example, a user device connecting to an advertisement, installing and operating an application, making a purchase payment, subscribing to a service, using a coupon usage, responding to a survey, and the like. For example, the probability of a user device performing a predetermined action may be the likelihood that the user device will make a purchase payment in an “Starbucks” application, which is a beverage application.

To this end, the operating unit 130 may calculate application weights of the applications installed in the user device, and the user-specific information weights of a user based on unique information received from the user device by a logistic regression method. Then, the probability of the user device performing a predetermined action may be calculated through the following Equation 1, which adds up the application weights assigned to the installed applications for each user device and the user-specific information weights.

$$user 1 = - 5.597007 + 0.2931738 \times 1 + 0.1179367 \times 1 + 0.5856063 \times 1 + 0.5361948 \times 0 + … - 0.544767 \times 0 - 0.722614 \times 0 = 0.323820 . \\ user 2 = - 5.597007 + 0.2931738 \times 1 + 0.1247751 \times 1 + 0.5856063 \times 0 + 0.5361948 \times 0 + … - 0.544767 \times 0 - 0.722614 \times 1 = 0.003152 . \\ user ( N + 1 ) = - 5.597007 + 0.2931738 \times 0 + 0.1247751 \times 1 + 0.5856063 \times 0 + 0.5361948 \times 0 + … - 0.544767 \times 0 - 0.722614 \times 0 = 0.920741 . \qquad [ Equation 1 ]$$

Referring to the Equation 1, user 1 is a user of the user device 1 who is a male having an age between 35 and 39 years, as shown in Table 1. Thus, a base weight of −5.597007, the user-specific information weight of 0.2931738 for being a male, the user-specific information weight of 0.1179367 corresponding to the age group of 35 and 39 are added. In addition, since only the ‘Starbucks’ application is installed in the user device 1, an application weight of 0.5856063 assigned to the ‘Starbucks’ application is added to the user device 1. As such, the probability for the user device 1 is calculated as 0.323820.

By performing the calculation according to Equation 1 for each of the user devices, the probability of whether each user device would perform a predetermined action may be calculated as a score having a value between 0 and 1.

In step S450, the candidate selecting unit 140 selects a target candidate for a marketing activity, so as to induce to target candidate to perform a predetermined action based on the calculated probability. In particular, the candidate selecting unit 140 may sort the user devices in descending order based on the scores of each user device, and may select user devices that meet a predetermined criteria. For example, the criteria may be set from a separate server, and may be defined as top 100 or 200 user devices having the highest score, or user devices having a score (or probability) of 0.5 or greater.

In addition, the data transmitting unit 160 may transmit at least one unique data for a user device selected as a target candidate to an external second server connected through a wire/wireless network. Accordingly, the second server may determine which device is the user device selected as the target candidate from the unique data received through the data transmission unit 150, and then actively promote a product or service to be advertised.

Hereinafter, a system and a method for providing a content to a target candidate selected through the above process will be described in more detail.

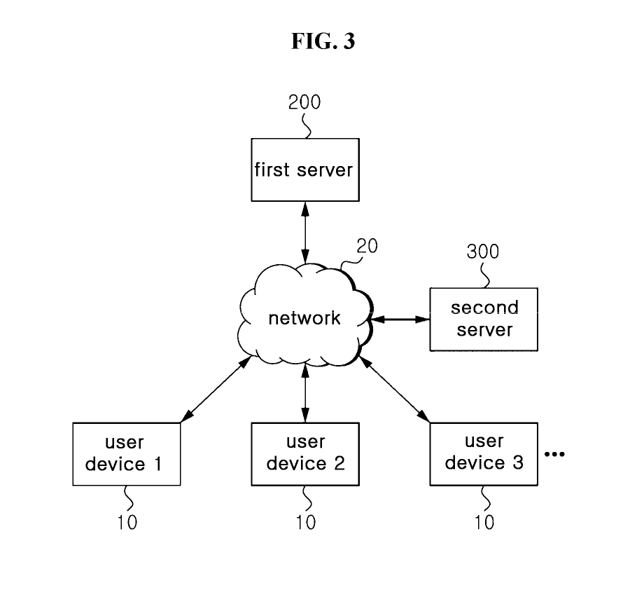

FIG. 3 is a schematic diagram of a content providing system for a target candidate according to an exemplary embodiment.

Referring to FIG. 3, the content providing system for a target candidate includes a first server 200 for selecting a target candidate among at least one user device, and a second server 300 for providing a content to the target candidate. The first server 200 may represent a service provider, and the second server 300 may represent an affiliate.

The first server 200 receives unique data including identification information of the user device and application information of an application installed in the user device from at least one user device 10 connected via a wire/wireless network. The first server 200 confirms the applications installed in each of the user devices 10, respectively.

The first server 200 generates an application installation list for each of the user devices 10. The first server 200 retrieves application weights for each of the applications, which have been previously stored and assigned to have different values from one another. The first server 200 applies the corresponding weights to the applications in the application installation list. The first server 200 then adds up the application weights of the applications installed in each user device 10, and calculates the probability of each user device 10 performing a predetermined action as a score.

The predetermined action that may be performed by the user device may include at least one of reproduction of content, installation and operating of an application, making a purchase payment, subscribing to a service, using a coupon, and responding to a survey.

In addition, the first server 200 selects a target candidate based on the score, to which a marketing activity may be performed, and transmits at least one unique data for the user device 10 selected as the target candidate to the second server 300. The unique data may include user-specific information, which includes at least one entries of gender, age, marital status, location, and income group for each user using the user device, each being assigned with user-specific information weight of different values.

In addition, the first server 200 may calculate the application weights and user-specific information weights, which are pre-stored values, based on a logistic regression method, and adds the application weights for the applications installed in the user device 10 and the user unique information weights, in order to calculate the probability for each user device. In addition, the first server 200 may sort the scores of the probability of the user device in descending order, and selects a user device that meets a preset criteria, such as a user device within a preset rank or having a score greater than a preset reference score.

The second server 300 identifies the user device 10 selected as the target candidate through at least one unique data received from the first server 200, and provides contents to the user device 10. The contents provided from the second server 300 may include at least one of cultural contents, advertisement contents, and payment related contents.

The cultural contents may include at least one of a novel, a cartoon, a webtoon, a game, a movie, a drama, and a musical. The advertisement contents may be information related to an application or a promotion that may induce the user device 10 to install or operate an application, subscribe to a service, make a purchase payment, response to a survey, or the like. In addition, the advertisement contents may also include a discount coupon or a mileage associated with a purchase made through the user device 10.

The second server 300 may issue discount coupons having different discount rates to the user device 10, according to the time that the second server 300 verifies the user device 10 as the target candidate through the unique data received from the first server 200.

In addition, the second server 300 may issue a mileage with different earning to points to the user device 10, according to the time that the second server 300 verifies user device 10 as the target candidate.

As described above, the advertisement content may include information that may induce the user device 10 to perform a predetermined action. In this case, when the user device 10 performs the predetermined action induced by the advertisement content, the second server 300 may transmit a fee for the advertisement to the first server 200. More particularly, the second server 300 may receive user action data from the user device 10, which may indicate whether the user device 10 has performed at least one of accessing the advertisement, installing and operating an application, making a purchase payment, subscribing to a service, using a coupon, or responding to a survey. The second server 300 may analyze the user action data, and then may pay the fee to the first server 200 upon determining that the user device 10 has performed one of the predetermined actions.

In particular, the first server 200 selects a target candidate among multiple user devices, transmits unique data of the selected target candidate to the second server 300. The second server 300 then provides an advertisement to the target candidate. In this case, each time the target candidate performs one of the actions predetermined by the second server 300, the second server 300 pays the advertisement fee to the first server 200 that has selected the target candidate. As such, the second server 300 may provide an advertisement to a target candidate, which is presumed to have a high interest to the goods and services promoted in the advertisement, thereby increasing the advertisement efficiency and lowering the costs associated with the advertisement.

According to an exemplary embodiment, the second server 300 may pay the advertisement fee to the first server 200 even when the number of times the advertisement is provided to the user device selected as the target candidate exceeds a preset reference number. More particularly, each time the second server 300 receives at least one unique data of the user device selected as the target candidate from the first server 200, the advertisement is provided from the second server 300 to the user device selected as the target candidate. The number of times the second server 300 provides the advertisement to the user device may refer to the number of times the user device selected as the target candidate is exposed to the advertisement.

For example, when the preset reference number is set as 1000, and the number of times that the second server 300 provides the advertisement to the user device selected as the target candidate exceeds 1000, the second server 300 may pay the advertisement fee to the first server 200 as the advertisement may be expected to have an effect from the advertisement. Therefore, since the advertisement transmitted from the second server 300 is provided and exposed to the user device selected as the target candidate, the number of times the advertisement is exposed may be verified, which may lower the advertisement costs.

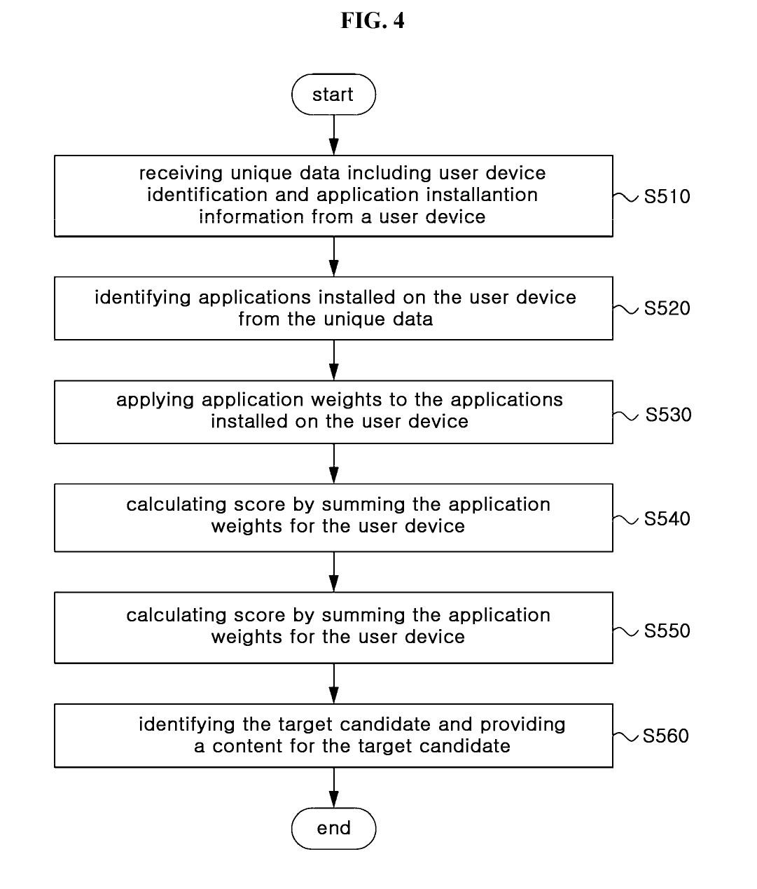

Hereinafter, a method of providing content to a target according to an exemplary embodiment will be described in detail with reference to FIG. 4.

FIG. 4 is a flowchart of a method for providing a content to a target according to an exemplary embodiment.

Referring to FIG. 4, an application weight is pre-assigned to each of the applications to have different value from each other, which are collected through a payment agency platform, such as PAYCO. In addition, each item of the user-specific information including at least one of gender, age, marital status, location, and income group for each user using the user device 10 may be pre-assigned and stored based on data previously collected through the payment agency platform.

In step S510, the first server 200 receives unique data including the identification information of the user device 10 and information of an application installed in the user device 10 through a wire/wireless network, from each of the user devices. The unique data may include user-specific information for each user who uses the user device 10. The user-specific information may include at least one of gender, age, marital status, location, and income group of each user, and each item in the user-specific information may be assigned with a user specific information weight different from one another.

In step S520, the first server 200 confirms the unique data received in step S510, and identifies an application installed in the user devices 10, respectively. At this time, after the first server 200 confirms the installed application in the user device 10, the first server 200 generates and stores the application installation list for each of the user devices 10.

In step S530, the first server 200 applies the application weights to applications installed in the user device 10, respectively. At this time, the first server 200 may also retrieve the user-specific information weights.

As shown in Table 3 above, the first server 200 may retrieve the application weights of the applications installed in the user device 10, that is, each application included in the application installation list, and user-specific information weights for each user of the user device 10. At this time, the pre-stored application weights and the user-specific information weights may be calculated differently depending on the type of marketing activities or types of the second server 300 performing the marketing activities.

In step S540, the first server 200 sums the application weights applied to the applications installed for the respective user devices 10, and calculates the probability of each user device 10 performing predetermined actions in scores. Here, the predetermined action that forms a basis of the score is an action that may be performed by each user device 10, such as accessing an advertisement, installing and operating a specific application, making a purchase payment, subscribing to a service, using a coupon, and responding to a survey, and the like. For example, the first server 200 may calculate the likelihood that each user device 10 makes a purchase payment in an ‘Artifice’ application, which is a bakery and beverage application, in terms of probability.

At this time, the first server 200 may calculate the application weights and user-unique information weights by using a logistic regression method. In this manner, the first server 200 may calculate the probability that the user device 10 performs a predetermined action through the Equation 1 described above.

By performing the calculation process of Equation 1 for each of the user devices 10, the probability of each user device 10 performing a predetermined action may be calculated as a score having a value between 0 and 1.

In step S550, the first server 200 transmits at least one unique data for a target candidate of the marketing activity to the second server 300 connected via the network.

In particular, the first server 200 may sort the user devices 10 in descending order on the basis of respective scores, and may be select the user devices as target candidates based on a predetermined criteria, such as top 100 or 200 user devices 10 with the highest scores, or user devices 10 having a score greater than a preset score determined by the second server 300, for example, 0.5.

Accordingly, in step S560, the second server 300 may precisely determine which user device 10 is selected as the target candidate from the unique data received from the first server 200, and the content is provided to the verified user device 10.

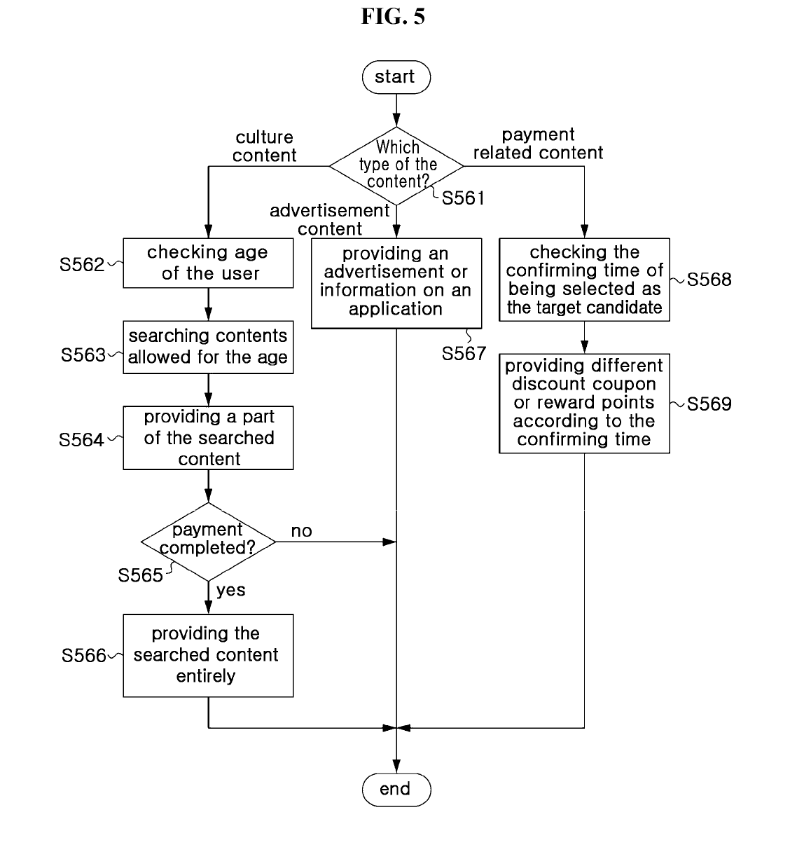

Hereinafter, a process of providing a content to a user device selected as a target candidate by the second server will be described in more detail with reference to FIG. 5.

FIG. 5 is a flowchart illustrating a detailed process of providing a content to a user device selected as a target candidate by a second server.

Referring to FIG. 5, in step S561, the second server 300 provides a content including at least one of the cultural contents, the advertisement contents, and the settlement related contents to the user device 10 selected as the target candidate.

The cultural contents may include at least one of a novel, a cartoon, a webtoon, a game, a movie, a drama, and a musical. In step S562, prior to providing the cultural contents, the second server 300 first confirms the user-specific information about the age from the unique data of the user device 10 selected as the target candidate. In step S563, the second server 300 may search the cultural contents permitted in the identified age range, and then, in step S564, the second server may provide the searched cultural contents to the user device 10 selected as the target candidate. In this case, only a part of the contents may be provided to the user device 10 as a preview, for example, first 1 minute of the contents, 10 pages, or 4 cuts, etc. In step S565, after the preliminarily preview period has passed, the purchase of the cultural contents by the user device 10 selected as the target candidate may be confirmed, and in step S566, the second server 300 may provide the purchased cultural contents to the user device 10 selected as the target candidate.

In step S567, the second server 300 provides an advertisement or application-related information to the user device 10, so as to induce the user device 10 to perform at least one of installing and running an application, making a purchase, subscribing to a service, and responding to a survey.

The settlement related contents may include a discount coupon or a mileage point used by the user device 10 in the purchase settlement. In particular, in step S568, the time at which the second server 300 identifies the user device 10 as a target candidate is checked. In step S569, a coupon having a discount rate that varies depending on the time checked by the second server 300 at step S568 is issued to the user device 10. For example, when the second server 300 confirms that a user device 10 is selected as the target candidate using the unique data received from the first server 200 at 9:00 AM, a 15% discount coupon may be generated, and when the second server 300 confirms that a user device 10 is selected as the target candidate at 9:00 PM, a 70% discount coupon is issued to the user device 10.

Coupons with varying discount rates may be useful in certain industries. For example, when the second server 300 is used for a bakery business, an advertisement effect to a product can be expected even with a low discount rate coupon when a product has a relatively long shelf life. However, a coupon with higher discount rate may be helpful to quickly sell a product with a relatively short shelf life or having an imminent expiration date, which may reduce inventory handling cost.

Alternatively, in step S569, the second server 300 may issue different mileage points according to the time that the second server 300 identifies a user device 10 as the target candidate, and may provide the selected mileage point to the user device 10. For example, when the second server 300 confirms that the user device 10 is selected as the target candidate by using the unique data received from the first server 200 at 9:00 AM, the second server 300 may issue 200 mileage points to the user device 10, and when at 9:00 PM, the second server 300 may issue a mileage point worth twice the purchase amount to the user device 10.

In addition, as described above, according to an exemplary embodiment, contents may be provided to a target candidate by a single server, instead of using multiple servers. More particularly, a content may be provided to a target using only one server, which receives unique data including identification information and application information from at least one user device.

Next, the server checks the installed application in the user device using the received unique data, and the server applies the application weights assigned to the installed applications in the user device.

Thereafter, the server calculates the probability of the user device performing a predetermined action as a score by summing the application weights applied to the application installed in the user device.

The server then selects a target candidate based on the calculated score, and selects a content to be provided to the target candidate using at least one unique data therefrom, and then provides the selected content to the target candidate for a marketing activity.

In this manner, the method of providing a content to a target is substantially similar to the method described above with reference to FIG. 2, except that only one server is used in the present exemplary embodiment, and that the process of transmitting at least one unique data of the target candidate to another server is omitted.

In addition, a content providing system for a target according to an exemplary embodiment includes one server and at least one user device.

At this time, the server receives unique data including identification information of the user device and application information of an application installed in the user device from at least one user device. The server identifies an application installed in the user device using the received unique data, and applies the application weights assigned to the installed applications. The server adds the application weights applied to the user device, and calculates a score based on the sum of application weights. The server then selects a target candidate based on the calculated score, and selects content of a marketing activity based on at least one unique data of the target candidate, which may be provided to the user device selected as the target candidate.

In order to provide contents to the target candidate using only a single server, the single server may initially receive multiple contents from different servers. Then, at least one of the previously received contents may be selected based on the unique data of the target candidate, which may then be transmitted to the target candidate.

As described above, according to exemplary embodiments, a method and a system for providing contents to a target candidate may include selecting a user device having a highly likelihood of performing a predetermined action as a target candidate, such that the contents of the promotion or advertisement may be efficiently provided to the target candidates.

In addition, according to exemplary embodiments, a method and system for providing contents to a target may provide different discount coupons or mileage points to a target candidate based on the time the merchant server confirms a user device as the target candidate, which may significantly reduce inventory handling costs.

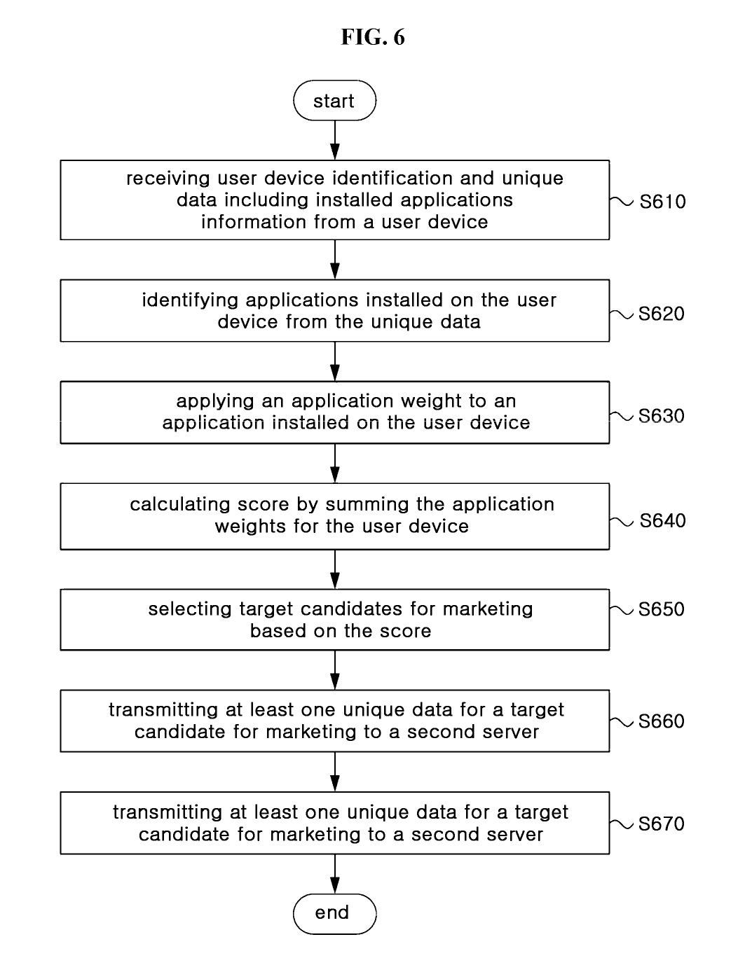

Hereinafter, an advertisement providing method to a target candidate according to an exemplary embodiment will be described in detail with reference to FIG. 6.

FIG. 6 is a flowchart of an advertisement providing method for a target candidate according to an exemplary embodiment.

Referring to FIG. 6, according to an exemplary advertisement providing method for the target candidate, the first server 200 first pre-assigns applications weights having different values to each of the applications, respectively, and stores the application weights, which are based on previously collected data through a payment agency platform, such as PAYCO. Also, the first server 200 may also pre-assign user-specific information weights to each items of user-specific information, such as gender, age group, marital status, location, and income group, for each user using the user devices, which are based on previously collected data through the payment agency platform.

In step S610, the first server 200 receives the unique data including the identification information of the user device and the application information of an application installed in the user device from the at least one user device 10 connected through a wire/wireless network. The unique data may further include user specific information including at least one of gender, age, marital status, location, and income group, and user-specific information weights having different values may be assigned to each item of the user-specific information.

In step S620, the first server 200 checks an application installed in the user device 10 from the unique data. At this time, the first server 200 may generate an application installation list for applications that are indicated in the unique data and identified to be installed in the user device 10.

In step S630, the first server 200 may retrieve application weights assigned to each application installed in the user device 10, which have different values from each other, and may calculate application weights assigned to the installed applications in the user device.

Then, in step S640, the first server 200 sums up the application weights applied to the applications, and calculates the score of the probability of each user device 10 performing a predetermined action. At this time, the first server 200 calculates application weights and user unique information weights by a logistic regression method. In this manner, the first server 200 may calculate the probability of each user device 10 performing the predetermined action in scores. More particularly, the predetermined action includes at least one of reproduction of content, installation and operating of application, purchase payment, subscription to a service, coupon usage, and survey response.

In step S650, the first server 200 selects a target candidate to which a marketing activity may be conducted based on the score of the user device 10. More particularly, the first server 200 may sort the scores of the user devices 10 in descending order, and a user device 10 included in a predetermined upper rank is selected as a target candidate, or a user device 10 having a score greater than a reference score is selected as a target candidate.

In step S660, the first server 200 transmits at least one unique data for the user device 10 selected as the target candidate to the second server 300 connected through a wired/wireless network.

The process performed in step S660 is substantially the same as the process described above with reference to FIG. 2, as such repeated description thereof will be omitted to avoid redundancy, and different features will be described in detail.

In step S670, the second server 300 confirms the target candidate through at least one unique data received from the first server 200, and provides an advertisement the target candidate.

Thereafter, the second server 300 transmits the advertisement fees to the first server 200 for the advertisement provided to the target candidate. In particular, when the target candidate performs a predetermined action, the second server 300 may pay the advertisement fee to the first server 200 based on the number of times the advertisement is provided to the target candidate.

More particularly, the second server 300 may receive behavior data from the target candidate, which identifies whether the target candidate has performed at least of accessing an advertisement, installing and operating an application, making a purchase payment, subscribing to a service, using a coupon, and responding to a survey. Then, the second server 300 analyzes the behavior data received, and once it is determined that the target candidate has performed one of the predetermined actions noted above, the second server 300 may pay the advertisement fees to the first server 200. In this manner, the behavior data may used to verify the interest of a user of the target candidate to the contents in the advertisement provided by the second server 300.

For example, when the behavior data indicates that the target candidate has performed one of the predetermined actions when the advertisement is received, the target candidate may be seen as having an interest to the contents of the advertisement. As such, the advertisement from the second server 300 to the target candidate may have a high efficiency.

As to the process of paying the fees from the second server 300 to the first server 200, the second server 300 may pay the fees to the first server 200 when the number of times the advertisement is provided to the target candidate exceeds a preset reference number. In particular, the second server 300 may provide an advertisement to the target candidate each time when the second server 300 receives a unique data of the target candidate from the first server 200. At this time, the number of advertisement provided to the target candidate refers to a number of times the advertisement is exposed to the user device of the target candidate.

For example, when the preset reference number is 1000, the second server 300 pays the first server 200 when the number of times the advertisement is provided to the target candidate exceeds 1000. In this manner, since the advertisement is exposed to the user device of the target candidate, the advertising cost can be effectively used.

The method and system for providing advertisements to the target candidate according to exemplary embodiments may include one or more servers.

According to exemplary embodiments, a server may predict the probability of each user device performing a predetermined action through an application installed in the user device through a logistic regression analysis, thereby efficiently selecting candidates that are appropriate to the contents of the advertisement.

In addition, a method and system for providing an advertisement to a target candidate according to exemplary embodiments may select a user device that is predicted to be highly likely to perform a predetermined action, which may increase the advertising efficiency. In addition, since the advertisement fees are paid only when the target candidate has performed a predetermined action, the advertisement cost can be used efficiently.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of selecting a candidate among a plurality of user devices to which an advertisement content is provided, the method comprising:
receiving, by a data receiving unit of a first server from each user device, a unique data comprising device identification information of the user device and application information of each application installed in the user device;
confirming, by the first server for each user device, the application installed in the user device from the unique data;
applying, by the first server for each user device, an application weight to each application installed in the user device, the application weight being different for each application;
summing, by the first server for each user device, the application weights applied to each installed application, and calculating a score of the user device based on the sum of the application weights; and
selecting at least one of the user devices as the target based on the score.

2. The method according to claim 1, wherein the unique data further comprises:
user-specific information comprising at least one of gender, age, marital status, location, and income group of each user using the user device; and
each of the gender, age, marital status, location, and income group of the user-specific information is assigned with a user-specific information weight different from one another.

3. The method according to claim 2, wherein:
each of the application weight and user-specific information weight are calculated by using a logistic regression method; and
the score of each user device is calculated by adding the application weights and the user-specific information weights of the corresponding user device.

4. The method according to claim 1, wherein the application weight for each application is predetermined.

5. The method of claim 1, wherein the score represents a probability of whether the user device performs at least one of predetermined actions comprising playing the content, installing and operating an application, making a purchase payment, subscribing to a service, using a coupon, and responding to a survey.

6. A method of selecting a target candidate among a plurality of user devices to which an advertisement content is provided, the method comprising:
receiving, by a first server from each user device, unique data comprising user device identification information of the user device and application information of each application installed in the user device;
checking, by the first server for each user device, whether the application in the unique data is installed in the user device;
applying, by the first server for each user device, an application weight to each application installed in the user device, each application weight having different values from one another;
summing, by the first server for each user device, the application weights applied to the installed applications, and calculating a score of the user device based on the sum of the application weights;
selecting, by the first server, at least one user device as the target candidate based on the score;
transmitting, by the first server, at least one unique data of the user device selected as the target candidate to a second server through a network; and
identifying, by the second server, the target candidate from the at least one unique data, and providing the advertisement content to the target candidate.

7. The method of claim 6, further comprising paying, by the second server, the advertisement fee to the first server.

8. The method of claim 7, wherein the step of paying the advertisement fee comprises:
receiving, by the second server from the target candidate, action data indicating whether the target candidate has performed at least one of accessing the advertisement, installing and operating an application, making a purchase payment, subscribing to a service, using a coupon, and responding to a survey; and
analyzing, by the second server, the action data received from the target candidate and paying the advertisement fee to the first server upon determining that the target candidate has performed the at least one of accessing the advertisement, installing an operating an application, making a purchase payment, subscribing to a service, using a coupon, and responding to a survey.

9. The method of claim 7, wherein the advertisement fee is paid to the first server if the number of times the advertisement has been provided to the target candidate exceeds a predetermined reference number.

10. The method of claim 6, wherein:
the unique data further comprises user-specific information comprising at least one of gender, age, marital status, location, and income group for each user using the user device; and
each of the gender, age, marital status, location, and income group of the user-specific information is assigned with a user-specific information weight different from one another.

11. The method of claim 10, wherein:
each of the application weight and user-specific information weight are calculated by using a logistic regression method; and
the score of each user device is calculated by adding the application weights and the user-specific information weights of the corresponding user device.

12. The method of claim 10, wherein the content of the advertisement varies depending on the gender, age, marital status, location, and income group of the user of the user device selected as the target candidate.

13. A server for selecting a target candidate comprising:
a data receiving unit configured to receive unique data from each user device, the unique data comprising user device identification information of the user device and application information of an application installed in the user device;
an operating unit configured to identify applications installed in the user device from the unique data received, apply application weights to applications installed in the user device, respectively, and to calculate a score of each user device based on the sum of the application weights; and
a candidate selection unit configured to select at least one user device as the target candidate based on the score of the corresponding user device.

14. The server of claim 13, wherein:
the unique data further comprises user-specific information comprising at least one of gender, age, marital status, location, and income group for each user using the user device; and
each of the gender, age, marital status, location, and income group of the user-specific information is assigned with a user-specific information weight different from one another.

15. The server of claim 14, wherein the operation unit is further configured to:
calculate the application weights and the user-specific information weights in a logistic regression method; and
calculate a probability by summing the applications weights and user-specific information weights of the corresponding user device as a score.

16. The server of claim 13, wherein the operating unit is further configured to:
retrieve the stored application weights for each of the applications; and
apply the application weights to the installed applications in the user device, respectively.

17. A system for providing an advertisement comprising:
the server of claim 13, the server configured to transmit the unique data of a user device selected as the target candidate; and
a second server configured to receive the unique data, identify the target candidate from the unique data, and provide an advertisement to the target candidate.

18. The system of claim 17, wherein the second server is further configured to pay an advertisement fee to the server for the advertisement provided to the target candidate.

19. The system of claim 18, wherein the second server is further configured to:
receive action data from the user device indicating whether the user device selected as the target candidate has performed at least one of accessing to the provided advertisement, installing and operating an application, making a purchase payment, subscribing to a service, using a coupon, and responding to a survey; and
analyze the received action data and paying the advertisement fee upon determining that the user device selected as the target candidate performed at least one of accessing to the provided advertisement, installing and operating an application, making a purchase payment, subscribing to a service, using a coupon, and responding to a survey.

20. The system of claim 18, wherein the second server is configured to pay the advertisement fee when the number of times the advertisement is provided to the user device selected as the target candidate exceeds a preset reference number.
